(19) United States
(12) Patent Application Publication
(10) Pub. No.: US 2026/0165251 A1
(43) Pub. Date: Jun. 18, 2026

(54) HARVESTING ATTACHMENT

(71) Applicant: DEERE & COMPANY, MOLINE, IL (US)

(72) Inventors: Maximilian Schroeder, Emsdetten (DE); Frank Schlamann, Gronau (DE); Dirk Bongert, Gesher (DE); Ralf Leveling, Gronau (DE)

(21) Appl. No.: 19/341,857

(22) Filed: Sep. 26, 2025

(30) Foreign Application Priority Data
Dec. 13, 2024 (EP) 24219816.6

(51) Int. Cl. A01D 61/02; A01D 34/66; A01D 61/00

(52) U.S. Cl. CPC A01D 61/02; A01D 34/66; A01D 61/002

(57) ABSTRACT

A harvesting attachment for plant harvesting may include a supporting framework, a mowing and intake device configured to cut plants and conveying the plants from a field, first and second transverse conveyor belts that are configured to receive the plants collected by the mowing and intake device and transversely convey the plants in a conveying direction that is oriented transversely to a forward direction of travel of the harvesting attachment. The first transverse conveyor belt or the second transverse conveyor belt is equipped with a driver orientated transversely to the conveying direction. The harvesting attachment may also include a discharge conveyor configured to receive the plants entering from the first transverse conveyor belt or the second transverse conveyor belt and conveyed the plants rearwards to a rear discharge opening of the harvesting attachment. The first transverse conveyor belt or the second transverse conveyor belt may also include an elevation.

### CROSS-REFERENCE TO RELATED APPLICATIONS

This application claims priority to European Patent Application No. 24219816.6, filed December 13, 2024, which is hereby incorporated by reference.

### FIELD OF THE DISCLOSURE

The present disclosure relates to a harvesting attachment for whole plant harvesting that can be attached to a harvesting machine and moved over a field in a forward direction.

### BACKGROUND OF THE DISCLOSURE

Some devices used for harvesting complete stalk-like plants, such as cereals or grass, are harvesting attachments with transverse conveyor belts (sometimes referred to as “draper belts”). Some harvesting attachments that harvest cereals are headers that hold plants or convey plants rearwardly using a reel, and the plants are cut with mowing knives. The harvested parts of the plants (interchangeably referred to as “harvested plants”) end up lying on transverse conveyor belts, and the harvested plants are transported by the transverse conveyor belts to the center of the harvesting attachment. There, harvested plants are received by a central conveyor belt, which conveys harvested plants rearwardly and discharges the harvested plants through a rear opening of the harvesting attachment into a feeder house. The feeder house conveys the harvested plants into a self-propelled harvesting machine, such as a combine harvester.

### SUMMARY

An example of the present disclosure is directed to a harvesting attachment for whole plant harvesting. The harvesting attachment may be attached to a harvesting machine and may be moved over a field in a forward direction. The harvesting attachment may include a supporting frame, a number of adjacent mowing and intake devices for severing plants and conveying the severed plants from the field; a first transverse conveyor belt and a second transverse conveyor belt configured to convey the severed plants gathered by the mowing and intake devices in a direction that is transverse to a longitudinal central plane of the harvesting attachment. At least one of the transverse conveyor belts may be equipped with drivers orientated transversely to the conveying direction. A discharge conveyor may be configured to move the harvested plants received from the transverse conveyor belts rearwardly to a rear discharge location of the harvesting attachment. The transverse conveyor belts may be equipped with elevations on front sides thereof.

Drivers of the conveyor belts may be orientated transversely to the conveying direction and distributed over a length of the conveyor belt. The transverse conveyor belts may include elevations on front sides thereof, and the elevations may interact with lower ends of the plants and improve the pick-up of the plants by the transverse conveyor belt.

The elevations may be formed such that the elevations are configured to capture lower ends of the harvested plants discharged by the mowing and intake devices and actively convey the harvested plants away from the mowing and intake devices. The drivers may include a leading edge which, starting from a front end in the forward direction, may extend obliquely rearwards with respect to a forward direction and obliquely rearwards or forwards with respect to the conveying direction. The leading edge may capture the lower end of an entering harvested plant and move the harvested plant forwards in the conveying direction and rearwards or forwards counter to the forward direction. For example, in some instances, the leading edge may include an conveying behavior for actively picking up and transporting the harvested plants. For example, with the leading edge extending obliquely rearwardly in the conveying direction from the front end of the attachment device, an underside of the harvested plants may be pushed rearwards counter to the forward direction. In some instances, with the leading edge extending obliquely forwards in the conveying direction from the front end, the underside of a harvested plant is pushed forwards in the forward direction. As a result, the plant may interact with the rear side of a stripper.

The elevations may extend continuously along the transverse conveyor belts, or adjacent elevations may be spaced apart from one another in the conveying direction of the transverse conveyor belts.

The elevations may be formed by zigzag-shaped webs that may include front-side pockets, or the elevations may be formed by fingers that extend obliquely with respect to the forward direction and with respect to the conveying direction of the transverse conveyor belt.

One or more of the mowing and intake devices may include a lower cutting disc and conveying discs arranged above the lower cutting disc with recesses distributed around a circumference of the conveying disc configured to received harvested plants severed by the cutting discs. The cutting discs may be configured to sever the plants from their roots, which remain in the ground.

### BRIEF DESCRIPTION OF THE DRAWINGS

The drawings illustrate an exemplary embodiments of the present disclosure that are described in more detail below. In the drawings:

FIG. 1 is a schematic view of an example harvesting machine with a harvesting attachment for whole plant harvesting, according to some implementations of the present disclosure.

FIG. 2 is a perspective view of the harvesting attachment of FIG. 1 as viewed from a left-hand side and obliquely in the rearward direction.

FIG. 3 is an enlarged perspective plan view of a part of the harvesting attachment of FIGS. 1 and 2,

FIG. 4 is an enlarged perspective plan view of a part of another example harvesting attachment, according to some implementations of the present disclosure.

FIG. 5 is a perspective view of an example conveyor belt of an example harvesting attachment according to FIGS. 1, 2, or 3.

FIG. 6 is a perspective view of the conveyor belt of the harvesting attachment of FIG. 4., and

FIG. 7 is an enlarged view of an example elevation in the form of a finger of the conveyor belt of FIG. 6.

### DETAILED DESCRIPTION

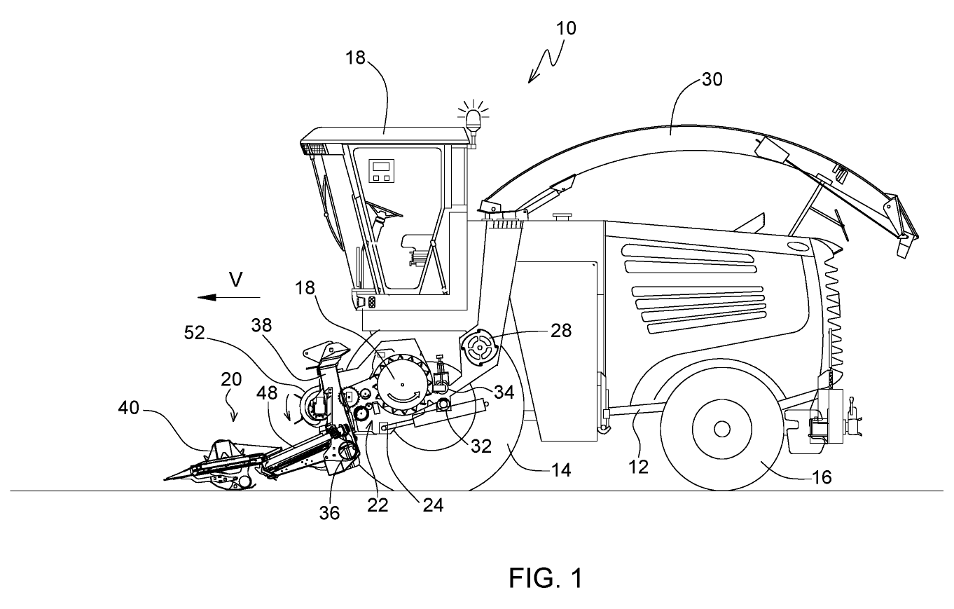

A self-propelled forage harvester 10 is illustrated in a schematic side view in FIG. 1. The forage harvester 10 is built on a frame 12, which is supported by driven front wheels 14 and steerable rear wheels 16. The forage harvester 10 is operated from a driver's cab 18, from which a harvesting attachment 20 for whole plant harvesting is visible. Crop, for example corn or other stalk-like plants, picked up from the ground by the harvesting attachment 20 are fed, via an intake conveyor 22, to the forage harvester 10. The intake conveyor 22 includes compression rollers, and the intake conveyor 22 is arranged within an intake housing 24 located on a front side of the forage harvester 10. The intake conveyor 22 feeds the plants to a chopper drum 26. The chopper drum 26 is arranged below the driver’s cab 18 and is configured to chop harvested crop into small pieces in co-operation with a counter-cutter. After the harvested crop has run through a post-processing device having two processor rolls 32, 34, the chopped crop is delivered to a conveyor 28. In some instances, the harvested crop exits the harvesting machine 10 and is delivered to a transporter. In some instances, the transporter travels alongside the forage harvester 10 when the harvested crop is delivered to the transporter. The forage harvester 10 delivers the crop material to the transporter via a discharge chute 30 that is rotatable about an approximately vertical axis and is adjustable in inclination.

In the following text, direction indications, such as laterally, downwards, and upwards, relate to the forward direction V of the forage harvester 10. As shown, the forward direction V runs to the left in FIG. 1.

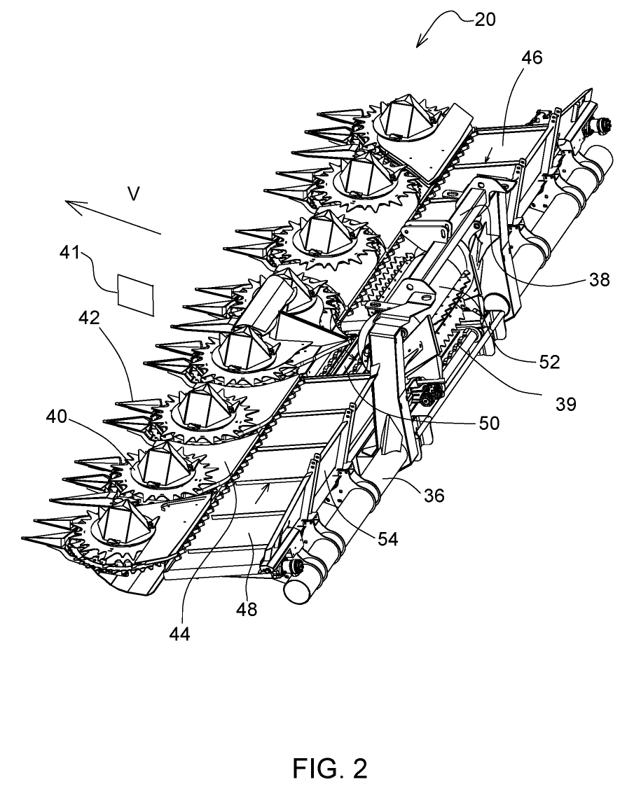

FIG. 2 is a perspective view of the harvesting attachment 20 configured for whole plant harvesting. The harvesting attachment 20 includes a supporting framework 36. The supporting framework 36 includes a rear mounting frame 38 that is provided at a middle of the supporting framework 36. The mounting frame 38 is used to attach the harvesting attachment 20 to the intake housing 24 of the forage harvester 10. As a discharge location for the harvested plants, the mounting frame 38 includes a central discharge opening 39, through which crop picked up from a field can be discharged into the intake conveyor 22.

On its front side, the supporting framework 36 holds a number (eight in the exemplary embodiment illustrated) of mowing and intake devices 40 of the kind used on conventional harvesting attachments for harvesting relatively large stalk-like plants, such as corn. The mowing and intake devices 40 include lower cutting discs (rotating or stationary) and conveying discs arranged above the lower cutting discs. The conveying discs include recesses distributed around a circumference thereof for receiving plants that are cut by the cutting discs from the roots of the plants. The roots of the plants remain in the ground. Stalk dividers 42 are arranged in front of the mowing and intake devices 40.

During harvesting, the mowing and intake devices 40 convey the plants on front sides of the mowing and intake devices 40 first of all laterally outwards, then rearwards and finally, by means of rear sides of the mowing and intake devices 40, inwards. In some implementations, the outer mowing and intake devices 40 operate in a direction opposite to the other mowing and intake devices 40 described above. The mowing and intake devices 40 discharge the plants in a state in which the plants are offset outwards relative to an axis of rotation of the mowing and intake devices 40, and strippers 44 lift the plants rearwards and inwards out of the recesses of the conveying discs of the mowing and intake devices 40. The strippers 44 penetrate into an enveloping circle of the conveying discs of the mowing and intake devices 40. Accordingly, the plants are discharged rearwards and inwards, and may be pushed along rearwardly, for example, by subsequently entering plants from the front . As a result, the plants are moved onto a transverse conveyor belt 46 or 48. During harvesting, the transverse conveyor belt 46 or 48 moves inwards, in a direction transverse to of a longitudinal central plane 41 of the harvesting attachment 20.

In the center of the harvesting attachment 20, the crop is taken over by a discharge conveyor 50. The discharge conveyor 50 moves the crop entering from the transverse conveyor belts 46 and 48 rearwards through the discharge opening 39 of the mounting frame 38 and into the intake conveyor 22. In the exemplary embodiment shown, the discharge conveyor 50 is designed as a conveyor belt. The two central mowing and intake devices 40 directly adjacent to the longitudinal central plane 41 of the harvesting attachment 20 deliver crop therefrom directly to the discharge conveyor 50. Rear walls 54 are provided to the rear of the transverse conveyor belts 46, 48. In the figures, the longitudinal axes (conveying directions) of the transverse conveyor belts 46, 48 extend transversely to the forward direction V. The transverse conveyors 46 and 48 could also be arranged in a V shape.

Above the discharge conveyor 50, upstream of the rear discharge opening, a roll 52 designed as a cylinder with conical ends is provided. The roll 52 facilitates the introduction of the plants into the discharge opening 39. The conical ends of the roll 52 are provided with helical drivers, while the central, cylindrical part of the roll 52 is provided with axially extending drivers. The roll 52 can be driven in the direction of the arrow illustrated in FIG. 1 or can rotate along freely.

Since all the cut-off plants are conveyed into the harvesting machine, the harvesting attachment 20 thus serves for whole plant harvesting of larger stalk-like plants, such as corn. In some instances, the mowing and intake devices 40 can also be used for introducing whole plant silage, e.g., cereal plants.

The upper sides of the transverse conveyor belts 46, 48, which are arranged horizontally or in a slightly forwardly and downwardly inclined state with respect to the forward direction V, move inwards during harvesting, while the upper side of the discharge conveyor 50, which is arranged horizontally or in a slightly rearwardly and upwardly inclined state with respect to the forward direction V, moves rearwards, as indicated by the arrows in FIG. 2. The mowing and intake devices 40 as well as the transverse conveyor belts 46, 48 and the discharge conveyor 50 and, where applicable, the roll 52 can be driven via a mechanical drive train from the forage harvester 10 carrying the harvesting attachment 20 or by associated electric or hydraulic motors (not shown), which provide for adjustment of the conveying speed and adaptation to the conveying speed in the intake conveyor 22 of the forage harvester 10 and thus to a cutting length of the plants.

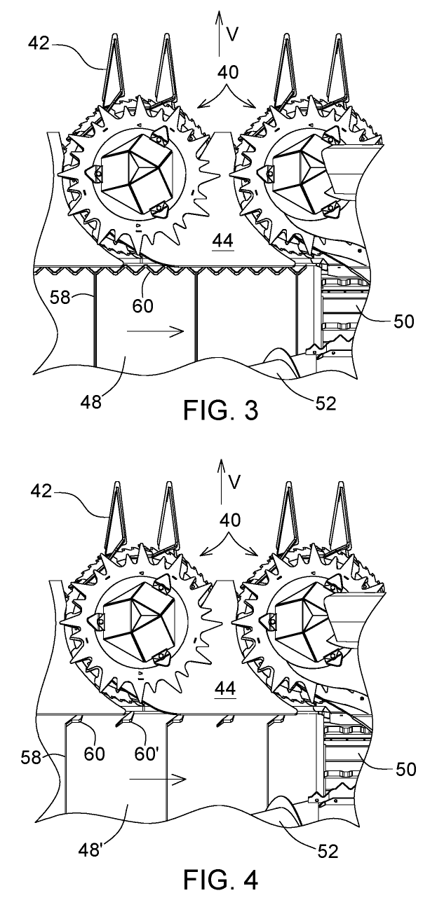

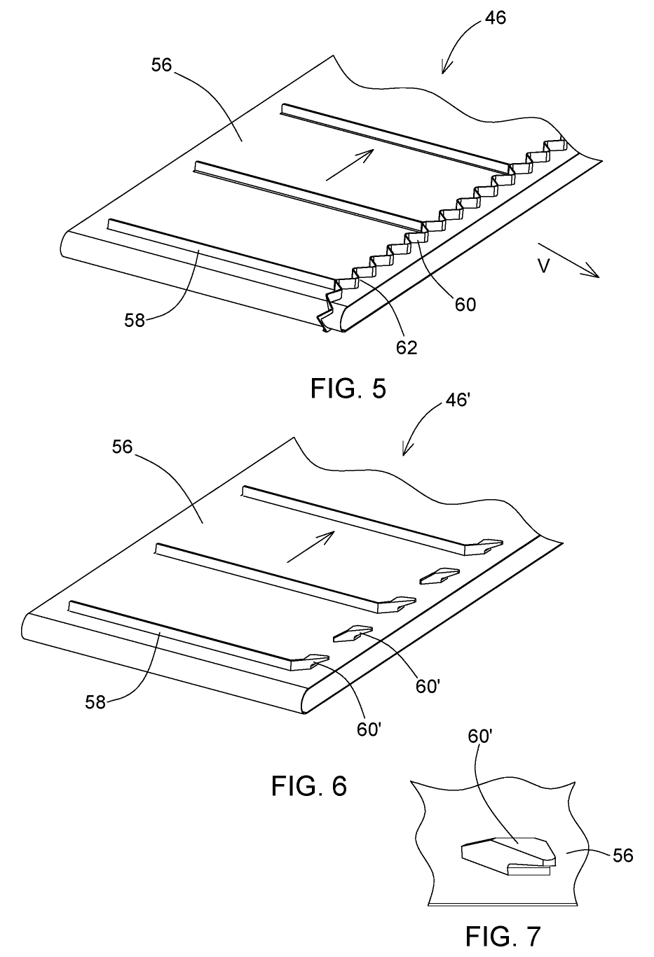

FIGS. 2, 3, and 5 show a first embodiment for the transverse conveyor belts 46 and 48. FIG. 5 shows the transverse conveyor belt 46, while the transverse conveyor belt 48 (not shown) is constructed with mirror symmetry, as seen relative to the longitudinal central plane 41 of the harvesting attachment 20, with respect to the transverse conveyor belt 46, and this applies analogously to the conveyor belts 46’, 48’ from FIGS. 4, 6, and 7. The transverse conveyor belts 46, 48 include endless conveyor belts 56 and drivers 58. The drivers 58 are attached to the belts and extend transversely to the conveying direction indicated by arrows and extend over the entire width of the conveyor belts 56 or a part thereof. Here, “endless” means that the ends of the conveyor belts 56 are connected to each other. The endless belts 56 can therefore be conveyor belts with ends detachably coupled by connection points or the two ends of the conveyor belts can be non-releasably connected, e.g., vulcanized together, or the conveyor belts can be manufactured in one piece.

Furthermore, the transverse conveyor belts 46, 48 according to a first embodiment have additional elevations 60 in the region of their front sides, which in the installed state are disposed directly adjacent to the mowing and intake devices 40. These web-like elevations 60 extend over the entire length of the transverse conveyor belt 46, 48, such as, in some instances, continuously. The elevations 60 are arranged immediately in front of the front ends of the drivers 58. In the plan view, the elevations 60 are loop-shaped or zigzag-shaped. As a result, the elevations 60 between adjacent drivers 58 form a number of forwardly open pockets 62, which are dimensioned such that a lower end of a vertically orientated plant stalk, e.g., corn stalk, fits into the pocket 62. The respective leading edge of the pockets 62 in the conveying direction, starting from a front end in the forward direction V, extends rearwards with respect to the forward direction V and forwards with respect to the conveying direction of the conveyor belts 46, 48, obliquely and at an angle of approximately 45°. In some implementations, the angle could be greater or less than 45°.

After the elevations 60 have received the plants from the mowing and intake devices 40 at the transfer locations at the rear of the mowing and intake devices 40, the pockets 62 are bounded at a front end, downstream of the transfer locations, by the strippers 44. The strippers 44 serve as strippers and a front boundary of the pockets 62. The plants are, therefore, pushed forwards by the leading edges of the pockets 62 in the conveying direction of the conveyor belts 46, 48 and with respect to the forward direction V. The rear edges of the strippers 44 hold the plants in the pockets 62 and prevent the lower ends of the plants from sliding forwards in the forward direction V out of the pockets 62.

Since the elevations 60 also move with the conveyor belts 56 around the deflection rollers of the latter, the elevations 60 are made of flexible materials, such as rubber. In some instances, it would be conceivable not to manufacture the zigzag-shaped elevations 60 in one piece, as shown in the drawings, but rather to construct the zigzag-shaped elevations 60 from cylindrical elements that project transversely from the surface of the conveyor belt 56. See, e.g., DE 102015117787 A1, the disclosure of which is incorporated in the present documents by way of reference. In some instances, A gap can be inserted between each of the elevations 60 forming a pocket 62, with the front side of the conveyor belt 46, 48 not being provided with elevations 60 in this gap, in a manner analogous to the embodiment according to FIGS. 4, 6, and 7. In the embodiment according to FIGS. 2, 3, and 5, the elevations 60 are arranged with their front edges to the rear of the strippers 44, and the elevations 60 do not project upwards beyond the strippers 44, although, in some instances, front edges of the elevations 60 do project upwards beyond the strippers.

In a second embodiment of the transverse conveyor belts 46’ and 48’, shown in FIGS. 4, 6, and 7, the elevations 60’ are also arranged on the front side of the endless conveyor belts 56, and, starting from front ends thereof, longitudinal axes of the elevations 60’ extend obliquely with respect to the forward direction V of the harvesting attachment 20 and obliquely with respect to the conveying direction of the transverse conveyor belt 46, 48’. In each case, the longitudinal axes of the elevations 60’ are directed rearwards (or, starting from a rear end thereof, obliquely forwards). Accordingly, the longitudinal axes of the elevations 60’ enclose an angle with both the forward direction V and the conveying direction of the conveyor belts 56 of the transverse conveyor belts 46, 46’, 48, 48’.

In the second embodiment, the individual elevations 60' are separated from one another and are arranged at a spacing apart from one another. In the embodiment shown, an elevation 60’ is positioned directly in front of a driver 58, e.g., the elevation 60’ directly adjoins a front end of the driver and extends obliquely with respect to the forward direction V and with respect to the conveying direction. In addition, as shown, for example, in FIG. 6, elevations 60' are attached approximately centrally between two directly adjacent drivers 58. The elevations 60’ are designed as fingers which extend upwards and obliquely forwards from an underside connected to the endless conveyor belts 56. In plan view, the elevations 60’ are wedge-shaped symmetrically with respect to their longitudinal axis and form a front tip. Viewed from the side, in the lower region, the elevations 60’ form a leading edge extending orthogonally to the surface of the endless conveyor belt 56. Above this edge, the elevations 60’ run forwards in a wedge shape, with an underside extending obliquely upwards and forwards and an upper side extending parallel to the surface of the endless conveyor belt 56. Although the front ends of the elevations 60’ project forwards beyond the stripper 44, the front ends of the elevations 60’ are located below the stripper 44. For example, the front ends of the elevations 60’ run along below the strippers 44. In some instances, the front ends of the elevations 60’ are located above the rear of the stripper 44, located to the rear of the stripper 44, or both. The leading edges of the elevations 60’, starting from a leading, front tip, are angled rearwards counter to the forward direction V and the conveying direction of the conveyor belts 48, 48’, at an angle of approximately 45°. In some instances, the angle may be greater or less than 45°.

The function of the elevations 60, 60’ of both embodiments is such that the elevations 60, 60’ provide active conveying for the lower ends of the plants that are discharged rearwards from the mowing and intake devices 40 to the transverse conveyor belt 46, 48 or 46’, 48’, because the lower ends of the plants are either picked up by the pockets 62 of the elevations 60 and, such as in co-operation with the rear edges of the strippers 44, conveyed therealong, or the plants are captured by the leading flanks of the elevations 60’ and carried along in the conveying direction of the transverse conveyor belts 46, 46’, 48, 48’ and directed rearwards counter to the forward direction V. In this way, in addition to the conveying effect of the drivers 58, the elevations 60, 60’ provide active conveying of the entering plants, which prevents the plants discharged by the mowing and intake devices 40 from sliding on the conveyor belt 56 and getting stuck or falling over and being carried exclusively along by the transverse conveyor belt 46, 46’, 48, 48’ at a later stage, if at all; instead, the plants are actively conveyed away by the elevations 60 or 60’.

As already mentioned, downstream of the transfer points, at which the elevations 60, 60’ receive the crop from the mowing and intake devices 40 at rear sides thereof, the elevations 60, 60’ co-operate with the rear ends of the strippers 44, which, on the one hand, serve as strippers for the mowing and intake devices 40 and, on the other hand, form an approximately vertically extending front boundary wall above the front edge of the transverse conveyor belts 46, 46’, 48, 48’. On the one hand, this cooperation provides the plant with support so that it does not slide forwards off the transverse conveyor belts 46, 46’, 48, 48’; on the other hand, this cooperation achieves the described conveying effect for the plants by means of the elevations 60 or 60’.

The present disclosure provides harvesting attachments equipped with transverse conveyor belts for harvesting whole plants, including larger plants such as corn, which reduce or eliminate problems associated with plants transitioning from the mowing and intake devices 40 to the transverse conveyor belt 46, 48 arranged at the rear of the mowing and intake devices 40.

1. A harvesting attachment for whole plant harvesting, the harvesting attachment configured to be attached to a harvesting machine and movable over a field in a forward direction, the harvesting equipment comprising:
a supporting framework defining a longitudinal axis that extends parallel to the forward direction and a central plane extending vertically and containing the longitudinal axis, the supporting framework defining a discharge opening;
a mowing and intake device configured to cut plants and convey the plants from the field,
a first transverse conveyor belt and a second transverse conveyor belt, wherein the first transverse conveyor belt or the second transverse conveyor belt is configured to receive the plants gathered by the mowing and intake device and convey the plants in a conveying direction that is oriented transversely to the central plane, wherein the first transverse conveyor belt or the second transverse conveyor belt includes a driver orientated transversely to the conveying direction; and
a discharge conveyor configured to receive the plants entering from the first transverse conveyor belt or the second transverse conveyor belt and configured to convey the plants rearwards to the discharge opening,
wherein the first transverse conveyor belt or the second transverse conveyor belt include:
a front side; and
an elevation disposed on the front side of the first transverse conveyor belt or the second transverse conveyor belt.

2. The harvesting attachment of claim 1, wherein the elevation is configured to capture a lower end of the plants discharged by the mowing and intake device and move the plants from the mowing and intake device.

3. The harvesting attachment of claim 2, wherein the elevation defines a zigzag shape.

4. The harvesting attachment of claim 1, wherein the elevation extends continuously along the first transverse conveyor belt or the second transverse conveyor belt.

5. The harvesting attachment of claim 1, wherein the elevation comprises a plurality of elevations, and wherein adjacent elevations of the plurality of elevations are spaced apart from one another in the conveying direction.

6. The harvesting attachment (20) of claim 4, wherein the elevation forms a web that defines a zigzag shape disposed along a front end of the first transverse conveyor belt or the second transverse conveyor belt, and wherein the web forms open pockets configured to receive a lower end of the plants entering from the mowing and intake device.

7. The harvesting attachment of claim 6, wherein the web extends continuously along the first transverse conveyor belt or the second transverse conveyor belt.

8. The harvesting attachment of claim 6, wherein the web forms one or more gaps over a length of the first transverse conveyor belt or the second transverse conveyor belt.

9. The harvesting attachment of claim 1, wherein the elevation comprises a plurality of elevations, wherein the plurality of elevations is formed by separate elements that project transversely from a surface of the first transverse conveyor belt or the second transverse conveyor belt, and wherein the plurality of elevations is configured to capture a lower end of the plants received from the mowing and intake devices.

10. The harvesting attachment of claim 1, wherein the elevation comprises a plurality of elevations, wherein the plurality of elevations is formed by fingers that are spaced apart from one another along a length of the first transverse conveyor belt or the second transverse conveyor belt, wherein the fingers project from a surface of the first transverse conveyor belt or the second transverse conveyor belt, and wherein the fingers extend forwards obliquely with respect to the forward direction and with respect to the conveying direction.

11. The harvesting attachment of claim 1, wherein the mowing and intake device includes a lower cutting disc and a conveying disc arranged above the cutting disc, wherein the conveying disc includes recesses distributed around a circumference thereof, and wherein the recesses are configured to receive plants that are cut by the cutting disc.

12. The harvesting attachment of claim 11, wherein, further comprising a stripper configured to penetrate into an envelope encircling the conveying disc, and wherein, on a rear side of the mowing and intake device, the stripper is configured to remove plants out of the recesses of the conveying disc.

13. The harvesting attachment of claim 12, wherein, downstream of a location at which the plants are discharged to the first transverse conveyor belt or the second transverse conveyor belt by the mowing and intake device, the stripper forms an approximately vertically extending front boundary wall that extends above the front end of the first transverse conveyor belt or the second transverse conveyor belt .

11. The harvesting attachment of claim 13, wherein the elevation comprises a plurality of elevations, wherein the plurality of elevations include front ends, and wherein the front ends of the plurality of elevations project forwards over the stripper, extend below are the stripper, or is located behind the stripper.
